(19) United States
(12) Patent Application Publication
(10) Pub. No.: US 2018/0322035 A1
(43) Pub. Date: Nov. 8, 2018

(54) AUTOMATION TESTING PLATFORM FOR FACILITATING AUTOMATIC TESTING OF AN INFORMATION TECHNOLOGY (IT) ENABLED APPLICATION

(71) Applicant: HCL Technologies Limited, Noida (IN)

(72) Inventors: Avishek MOHANTY, Noida (IN); Balasubramaniam NALLATHAMBI, Bangalore (IN); Saravanakumar VELUCHAMY, Chennai (IN); Suresh VENKATESAN, Chennai (IN); Naga Babu MERAM, Hyderabad (IN)

(21) Appl. No.: 15/672,135

(22) Filed: Aug. 8, 2017

(30) Foreign Application Priority Data
May 4, 2017 (IN) 201711015809

(51) Int. Cl. G06F 11/36; G06F 9/44

(52) U.S. Cl. CPC G06F 11/3684; G06F 11/3664; G06F 8/70; G06F 11/3696; G06F 11/3688

(57) ABSTRACT

Disclosed is an automation testing platform for facilitating automatic testing of an Information technology (IT) enabled application. A data capturing module captures one or more objects and at least one action performed on the one or more objects. A re-usable test script creation module creates a plurality of re-usable test scripts based on the one or more objects and the at least one action. A keyword assignment module assigns a unique keyword to each re-usable test scripts. A mapping module stores a mapping table comprising mapping of the unique keyword and each of the plurality of re-usable test scripts. A keyword selection module selects the unique keyword, corresponds to a re-usable test script of the plurality of re-usable test scripts, from the mapping table. A test script execution module executes the re-usable test script thereby facilitating automatic testing of the specific use-case pertaining to the IT enabled application.

### CROSS REFERENCE TO RELATED APPLICATIONS

This patent application claims priority from Indian Application No. 201711015809 filed on May 4, 2017, the entirety of which is hereby incorporated by reference.

### TECHNICAL FIELD

The present subject matter described herein, in general, relates to facilitate automatic testing of an Information technology (IT) enabled application. More specifically, an automation testing platform for automatically testing the IT enabled application by using re-usable test scripts.

### BACKGROUND

With the emergence of digital business, the future of business technology has come into sharper focus. While over 90% of large organizations are pursuing digital initiatives as per Gartner Report. However, given that industry has accepted for some time that automation is the way forward and will be the most crucial part of Digitalization, the paradox is that leading research reports suggest that automation maturity in the industry is around 8% to 10% (i.e. 70% or higher test cases are automated), 12% of organizations have no automation at all, and 54% organizations lack suitable tools for test automation.

Many organizations may automate their integrations, builds and delivery processes however such organizations may still face trouble with the subtleness of test orchestration and automation. For automation to succeed, it requires an automated end-to-end testing solution that integrates into a Software Lifecycle. With an advent of digitalization, mobility, expansion of social media, the challenge with the present method of automation is that there is no one stop shop for automation. Every different automation challenge may require a different solution. In a typical enterprise today almost all technologies may be found in the IT landscape, like SAP™, Mainframe™, Java™, Dot Net™ etc. The other challenge to address is customer (end user) experience through support of multiple browsers, devices etc.

To address these challenges, enterprises may fall back on specific tools that addresses these challenges. Though the problem is solved for specific areas, the automation at an enterprise level doesn't provide adequate Return of Investment (ROI). The reason being with multiple tools, frameworks and solutions the cost spiral up negating the benefits of automation. In addition to the challenge associated with the ROI, the other challenge would be to automate a simple process as it may require programming expertise in programming languages based on the automation tool.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for facilitating automatic testing of an Information technology (IT) enabled application and the concepts are further described below in the detailed description. This summary is not intended to identify essential features of the claimed subject matter nor is it intended for use in determining or limiting the scope of the claimed subject matter.

In one implementation, an automation testing platform for facilitating automatic testing of an Information technology (IT) enabled application is disclosed. The automation testing platform may comprise a processor and a memory coupled to the processor. The processor may execute a plurality of modules present in the memory. The plurality of modules may comprise a data capturing module, a re-usable test script creation module, a keyword assignment module, a mapping module, a keyword selection module, and a test script execution module. The data capturing module may capture one or more objects and at least one action performed on the one or more objects. In one aspect, the one or more objects may be present on at least one page of the IT enabled. The re-usable test script creation module may create a plurality of re-usable test scripts and a plurality of keywords. The plurality of re-usable test scripts and the plurality of keywords may be created based on the one or more objects and the at least one action. In one aspect, each re-usable test script may be created to test a specific use-case pertaining to the IT enabled application. The keyword assignment module may assign a unique keyword to each re-usable test scripts. The mapping module may store a mapping table comprising mapping of the unique keyword and each of the plurality of re-usable test scripts. The keyword selection module may select the unique keyword, corresponds to a re-usable test script of the plurality of re-usable test scripts, from the mapping table. It may be understood that the selection of the unique keyword may indicate testing of the specific use-case. The test script execution module may execute the re-usable test script thereby facilitating automatic testing of the specific use-case pertaining to the IT enabled application.

In another implementation, a method for facilitating automatic testing of an Information technology (IT) enabled application is disclosed. In order to facilitate automatic testing, initially, one or more objects and at least one action performed on the one or more objects may be captured. In one aspect, the one or more objects may be present on at least one page of the IT enabled. Upon capturing the one or more objects and the at least one action, a plurality of re-usable test scripts and a plurality of keywords may be created based on the one or more objects and the at least one action. It may be understood that each re-usable test script may be created to test a specific use-case pertaining to the IT enabled application. Subsequent to the creation of the plurality of re-usable test scripts, a unique keyword may be assigned to each re-usable test scripts. Post assignment of the unique keyword, a mapping table comprising mapping of the unique keyword and each of the plurality of re-usable test scripts may be stored. After storing the mapping table, the unique keyword, corresponds to a re-usable test script of the plurality of re-usable test scripts, may be selected from the mapping table. In one aspect, the selection of the unique keyword may indicate testing of the specific use-case. Subsequently, the re-usable test script may be executed thereby facilitating automatic testing of the specific use-case pertaining to the IT enabled application. In one aspect, the aforementioned method for facilitating the automatic testing of the IT enabled application may be performed by a processor using programmed instructions stored in a memory.

In yet another implementation, non-transitory computer readable medium embodying a program executable in a computing device for facilitating automatic testing of an Information technology (IT) enabled application is disclosed. The program may comprise a program code for a program code for capturing one or more objects and at least one action performed on the one or more objects, wherein the one or more objects are present on at least one page of the IT enabled. The program may further comprise a program code for creating a plurality of re-usable test scripts and a plurality of keywords, wherein the plurality of re-usable test scripts and the plurality of keywords are created based on the one or more objects and the at least one action, wherein each re-usable test script is created to test a specific use-case pertaining to the IT enabled application. The program may further comprise a program code for assigning a unique keyword to each re-usable test scripts. The program may further comprise a program code for storing a mapping table comprising mapping of the unique keyword and each of the plurality of re-usable test scripts. The program may further comprise a program code for selecting the unique keyword, corresponds to a re-usable test script of the plurality of re-usable test scripts, from the mapping table, wherein the selection of the unique keyword indicates testing of the specific use-case. The program may further comprise a program code for executing the re-usable test script thereby facilitating automatic testing of the specific use-case pertaining to the IT enabled application.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of an automation testing platform for facilitating automatic testing of an Information technology (IT) enabled application, in accordance with an embodiment of the present subject matter.

FIG. 2 illustrates the system, in accordance with an embodiment of the present subject matter.

FIG. 3 illustrates an implementation of the automation testing platform, in accordance with an embodiment of the present subject matter.

FIG. 4 illustrates a method for facilitating automatic testing of the IT enabled application, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

It may be understood that the present testing tools necessitate a user to build automated test scripts through extensive coding each time the user has to test automatically any Information technology (IT) enabled application even though a similar IT enabled application has been tested before. To overcome the coding aspect, recurrence of building automated test scripts, an automation testing platform for facilitating automatic testing of the IT enabled application is disclosed. The automation testing platform brings advantageous features such as creation of automation scripts through a user friendly UI without the need of writing or typing any code, creation of re-usable automated test scripts, comprehensive need based reporting, cost and time efficient inbuilt frameworks for Hybrid, data driven, Behaviour Driven, Mobility framework, SOA framework under one umbrella platform. The automation testing platform alleviates the need for additional skilled personnel for testing the IT enabled application. It may be understood that the automation testing platform may be integrated seamlessly with any test automation tools, including licensed and open source products. Examples of the functional automation tools may include, but not limited to, Unified Functional Tester (UFT), and Open source tools including, but not limited to, Selenium™, Appium™.

It may further be understood that the automation testing platform obviates a user to be skilled in programming skills as the automation testing platform allows the user to test the IT enabled application by using re-usable test scripts accessed through dropdowns from a web based user friendly UI. To do so, one or more objects and at least one action performed on the one or more objects (associated to at least one page of the IT enabled application) may be captured. Upon capturing the one or more objects and the at least one action, a plurality of re-usable test scripts and a plurality of keywords may be created. Subsequently, a unique keyword may be assigned to each re-usable test scripts. After assigning the unique keyword, a mapping table, comprising mapping of the unique keyword and each of the plurality of re-usable test scripts, may be stored in a system database. Once the mapping table is stored, the unique keyword, corresponds to a re-usable test script of the plurality of re-usable test scripts, may be selected from the mapping table. In one aspect, the selection of the unique keyword indicates testing of the specific use-case. After selection of the unique keyword, the re-usable test script may be executed independently or using any Test management system seamlessly integrated with the automation testing platform. Examples of the at least one Test management system includes HP™ ALM/QC, Testlink™ and CI tools (such as Jenkins™ and TeamCity™).

Thus, in this manner, the automation testing platform enables the user, not skilled in the programming skills, to test the IT enabled application with significant reduction in testing efforts and reusability of the test scripts. While aspects of described system and method for facilitating automatic testing of the IT enabled application and may be implemented in any number of different computing systems, environments, and/or configurations, the embodiments are described in the context connected vehicles.

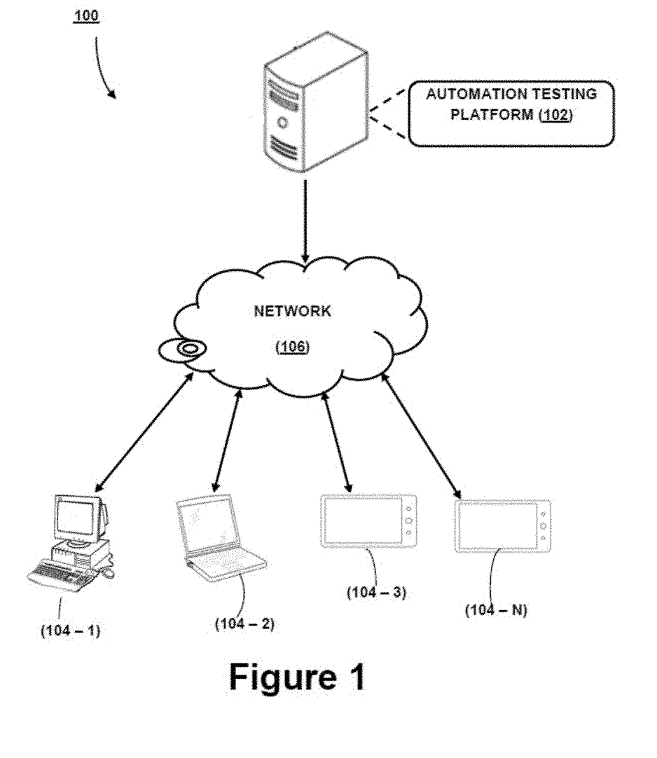

Referring now to FIG. 1, a network implementation 100 of an automation testing platform 102 for facilitating automatic testing of an Information technology (IT) enabled application is disclosed. In order to facilitate automatic testing, initially, the automation testing platform 102 captures one or more objects and at least one action performed on the one or more objects. Upon capturing the one or more objects and the at least one action, the automation testing platform 102 creates a plurality of re-usable test scripts and a plurality of keywords, wherein the plurality of re-usable test scripts and the plurality of keywords are created based on the one or more objects and the at least one action. It may be understood that each re-usable test script may be created to test a specific use-case pertaining to the IT enabled application. Subsequent to the creation of the plurality of re-usable test scripts, the automation testing platform 102 assigns a unique keyword to each re-usable test scripts. Post assignment of the unique keyword, the automation testing platform 102 stores a mapping table comprising mapping of the unique keyword and each of the plurality of re-usable test scripts. After storing the mapping table, the automation testing platform 102 selects the unique keyword, corresponds to a re-usable test script of the plurality of re-usable test scripts, from the mapping table. In one aspect, the selection of the unique keyword may indicate testing of the specific use-case. Subsequently, the automation testing platform 102 executes the re-usable test script thereby facilitating automatic testing of the specific use-case pertaining to the IT enabled application.

Although the present disclosure is explained considering that the automation testing platform 102 is implemented on a server, it may be understood that the automation testing platform 102 may be implemented in a variety of computing systems, such as a laptop computer, a desktop computer, a notebook, a workstation, a mainframe computer, a server, a network server, a cloud-based computing environment. It will be understood that the automation testing platform 102 may be accessed by multiple users through one or more user devices 104-1, 104-2 . . . 104-N, collectively referred to as user 104 or stakeholders, hereinafter, or applications residing on the user devices 104. In one implementation, the automation testing platform 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the automation testing platform 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

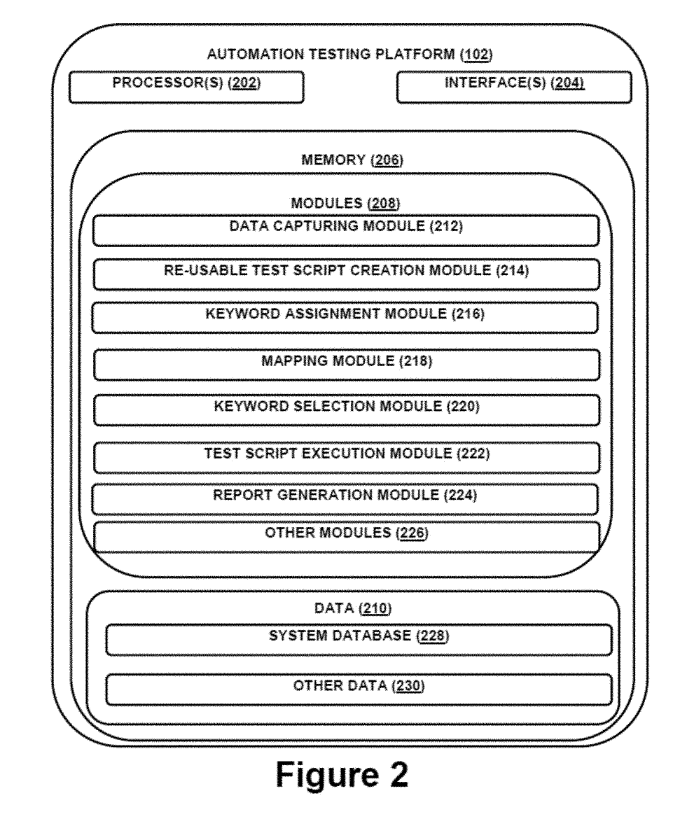

Referring now to FIG. 2, the automation testing platform 102 is illustrated in accordance with an embodiment of the present subject matter. In one embodiment, the automation testing platform 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the automation testing platform 102 to interact with the user directly or through the client devices 104. Further, the I/O interface 204 may enable the automation testing platform 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data capturing module 212, a re-usable test script creation module 214, a keyword assignment module 216, a mapping module 218, a keyword selection module 220, a test script execution module 222, a report generation module 224, and other modules 226. The other modules 226 may include programs or coded instructions that supplement applications and functions of the automation testing platform 102. The modules 208 described herein may be implemented as software modules that may be executed in the cloud-based computing environment of the automation testing platform 102.

The data 210, amongst other things, serves as a repository for storing data processed, received, and generated by one or more of the modules 208. The data 210 may also include a system database 228, and other data 230. The other data 230 may include data generated as a result of the execution of one or more modules in the other modules 222.

As there are various challenges observed in the existing art, the challenges necessitate the need to build the automation testing platform 102 for facilitating automatic testing of an Information technology (IT) enabled application. In order to translate the data, at first, a user may use the client device 104 to access the automation testing platform 102 via the I/O interface 204. The user may register them using the I/O interface 204 in order to use the automation testing platform 102. In one aspect, the user may access the I/O interface 204 of the automation testing platform 102. The automation testing platform 102 may employ the data capturing module 212, the re-usable test script creation module 214, the keyword assignment module 216, the mapping module 218, the keyword selection module 220, the test script execution module 222, and the report generation module 224. The detail functioning of the modules is described below with the help of figures.

In order to facilitate automatic testing of the IT enabled application, initially, the data capturing module 212 captures one or more objects and at least one action performed on the one or more objects. Example of the one or more object includes a textbox, a dropdown list, and a submit button. In one aspect, the IT enabled application to be tested is one of a Desktop application, a web-based application, and a mobile application. It may be understood that the one or more objects may be present on at least one page of the IT enabled application. Subsequent to the capturing of the one or more objects and the at least one action, the re-usable test script creation module 214 creates a plurality of re-usable test scripts and a plurality of keywords. In one aspect, the plurality of re-usable test scripts and the plurality of keywords may be created based on the one or more objects and the at least one action. In one aspect, each re-usable test script may be created to test a specific use-case pertaining to the IT enabled application.

In one embodiment, the plurality of re-usable test scripts may be created by monitoring the at least one action performed on the one or more objects and thereby recording the at least one action performed on the one or more objects. For example, in order to create the plurality of re-usable test scripts, consider an example where an action log file or database storing each action, performed with the one or more objects for the IT enabled application under test, as text. The action log file or database may be used to create the steps in the plurality of re-usable test scripts, or to provide a quick start for creating the steps, without having to retype each action. It may be understood that the action log file or database may be created by using a recording function in which the dry run may performed on a trial IT enabled application. By using the recording function, a set of test scripts may be created which then be re-used for testing the IT enabled application similar to the trial IT enabled application.

For example, a test captioned “Add Item to Shopping Cart” may be created with just one test step named Create Test Steps. By using test settings to collect the action log, test and perform all the necessary actions to add an item to your shopping cart. Each UI action is stored in the database upon execution of the test. In one aspect, the text in the action log file—can be modified (if required) to create a new set of test scripts using the existing set of test scripts using the UI. Thus, in this manner, the data capturing module 212 and the re-usable test script creation module 214 facilitates to create the plurality of re-usable test scripts based on the one or more objects and the at least one action. Similarly, Test data can be either passed as a parameter in the test step or upload in bulk for multiple iterations of test execution using multiple data combinations

Subsequent to the creation of the plurality of re-usable test scripts, the keyword assignment module 216 assigns a unique keyword to each re-usable test scripts. In one aspect, the keyword may be assigned to identify a re-usable test script, from the plurality of re-usable test scripts, for testing the specific use-case. Upon assigning the unique keyword, the mapping module 218 stores a mapping table comprising mapping of the unique keyword and each of the plurality of re-usable test scripts. In one aspect, the mapping table may be stored in the system database 228. After storing the mapping table, the keyword selection module 220 selects the unique keyword, corresponds to a re-usable test script of the plurality of re-usable test scripts, from the mapping table. It may be understood that the selection of the unique keyword indicates testing of the specific use-case intended by a user. Upon selection of the unique keyword, the test script execution module 222 executes the re-usable test script thereby facilitating automatic testing of the specific use-case pertaining to the IT enabled application. In aspect, after executing the selected re-usable test script, the report generation module 224 generates a report comprising test results and a screen-shot indicating at least one bug identified upon execution of the re-usable test script.

In order to elucidate the functioning of the above modules, consider an example wherein a plurality of re-usable test scripts (i.e. TS₁, TS₂, TS₃, TS₄, . . . , and Tₙ) are created. Upon creating the test scripts TS₁, TS₂, TS₃, TS₄, . . . , and Tₙ, the keyword assignment module 216 enables a user to assign a unique keyword to each one of TS₁, TS₂, TS₃, TS₄, . . . , and Tₙ. For example, the below table (1) indicates that the user assigns the unique keyword to each of TS₁, TS₂, TS₃, TS₄, . . . , and Tₙ.

TABLE 1

| TEST CASE | UNIQUE KEYWORD |
|---|---|
| TS₁ | Login_Page_Validation |
| TS₂ | Add_to_Cart_Validation |
| TS₃ | Submit_button_Validation |
| TS₄ | Product_Purchase_Validation |
| Tₙ | Payment_Validation |

Post assignment of the unique keyword to each of TS₁, TS₂, TS₃, TS₄, . . . , and Tₙ, as shown in the table 1, the table 1 is stored in the system database 228 for future reference. It may be understood that the table may be appended by addition any number of new re-usable test scripts pertaining to a new use-case. By this way, the table may be updated and thereby stored in the system database 228. It may further be understood that the S₁, T₂, TS₃, TS₄, . . . , and Tₙ, stored on the system database 228, may be displayed to the user in a dropdown list of a User Interface (UI). In order to use the re-usable test script, the user may select a re-usable test script from the dropdown list based on the user-case to be tested. For example, if the user wishes to test the functionality of Login page, the user selects the keyword ‘Login_Page_Validation’ from the dropdown list. Similarly, if the user wishes to test the whether the functionality pertaining to a Product/commodity purchased on an ecommerce website is working properly as the desired workflow, the user selects the keyword ‘Product_Purchase_Validation’ from the dropdown list. Upon selection of the unique keyword, the test script execution module 222 executes the re-usable test script (i.e. TS₁ and TS₄ respectively) by using at least one Test management system in order to test the functionality of Login page or Product/commodity purchased on the ecommerce website respectively. Thus, in this manner, the automation testing platform 102 facilitates to automatic test the specific use-case pertaining to the IT enabled application without any prior expertise of programming languages.

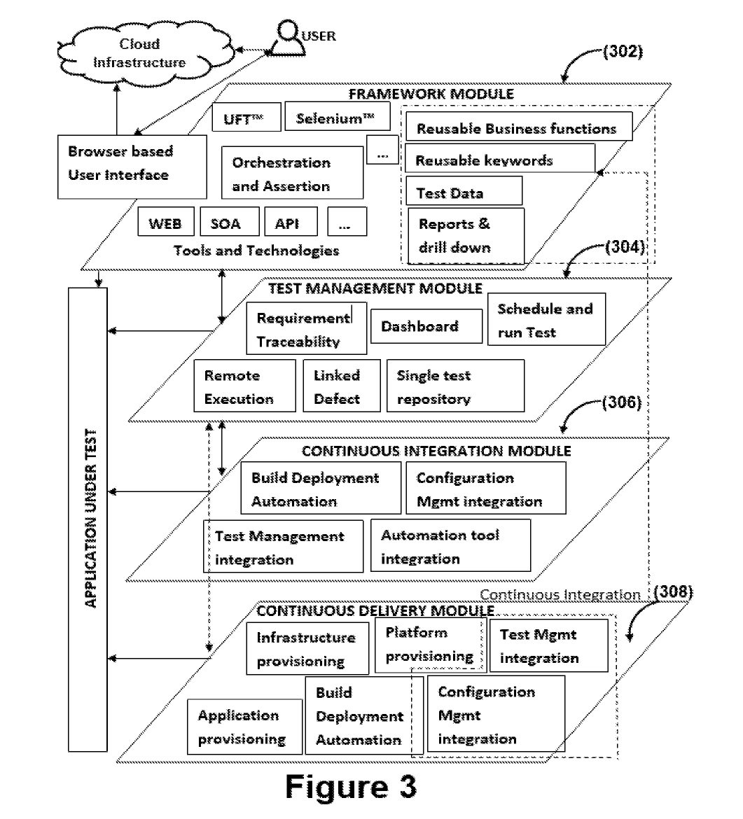

Referring to the FIG. 3. It may be understood that the automation testing platform may be integrated with additional plug-ins in order to provide an end to end automated solution for testing an IT enabled application without programming code. As shown in the FIG. 3, the automation testing platform 102 comprises four plugins that may be plugged with the automation testing platform. The four plugins are Framework module 302, Test Management Module 304, Continuous Integration module 306, and Continuous delivery module 308. The details pertaining to each plug is described below.

The Framework Module 302 consists of three underlying layer (i) UI and DB Layer (ii) Framework Layer (iii) Tools Layer. In one aspect, the UI and DB layer is a Web based User friendly UI to create automate scripts leveraging the reusable objects, business functions, custom functions, key words and Test Data. Upon creation, the scripts may be stored in the system database 228 so that the scrips may be referred later for reuse, modification or automated execution. The Framework Layer, on the other hand, has multiple underlying frameworks like Hybrid, Keyword, Modular, Data Driven, BDD, SOA, and Mobility to allow users to choose functions, keywords etc. in order to create scripts from UI. For example—if a user wants to automate mobile application or a website using keyword method, the user has to select a script from the UI. Upon selection, the UI invokes the respective framework by interacting with the framework Layer and populates the reusable components for that framework on the UI. Using these reusable business functions, objects and keywords from drop down boxes, the automation scripts may be created without writing programming code. The final layer is the tool layer where all automation tools including, but not limited to, HP UFT™, IBM™ RFT™, Selenium™, Appium™, Soap™ UI which are used for the automated execution of the test cases. Upon execution from the UI, the automation tools are called and the script, to be executed, is passed to the tool for execution on the Application under testing.

The Test Management Module 304 integrates the automation testing platform 102 with various Test Management tools like HP™ QC, Test Link™, Zephyr™, which are used for storing manual test cases and requirements. Through the Test Management module 304, the automation testing platform 102 ensures traceability between requirements, manual test cases in the Test management tools and automation scripts in the automation testing platform 102. In addition to the above, the Test Management Module 304 further integrates with Defect management tools like HP™ QC, Bugzilla™, Jira™ to automatically log defect incase an automation script created in the automation testing platform 102 executed through automation tool detects anomaly in the application under test.

The Continuous Integration Module 306 integrates the automation testing platform 102 with multiple CI tools like Jenkins™, Bamboo™ that are used to integrate different development build into one build. The Continuous Integration Module 306 further ensures that once builds are integrated by the CI tool, the automation testing platform 102 is triggered automatically to execute previously specified automated scripts against IT enabled application under test.

The Continuous Delivery Module 308 integrates the automation testing platform 102 with multiple CD tools which are used to provision different applications and infrastructure. Further the Continuous Delivery Module 308 ensures that once environments are provisioned and builds deployed, the automation testing platform 102 is triggered automatically to execute previously specified automated scripts against IT enabled application under test.

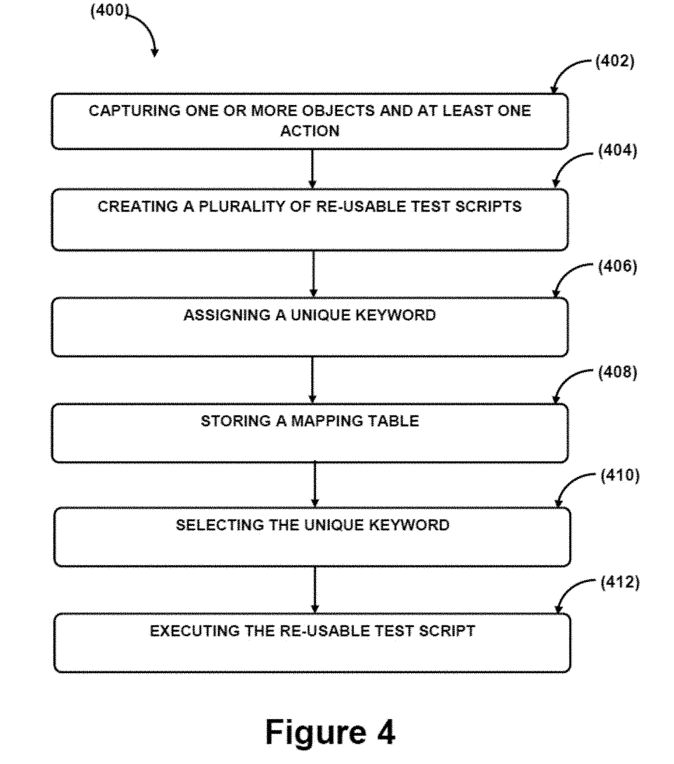

Referring now to FIG. 4, a method 400 for facilitating automatic testing of an Information technology (IT) enabled application is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the automation testing platform 102.

At block 402, one or more objects and at least one action performed on the one or more objects may be captured. In one aspect, the one or more objects are present on at least one page of the IT enabled. In one implementation, the database schema may be defined by the data capturing module 212.

At block 404, a plurality of re-usable test scripts and a plurality of keywords may be created based on the one or more objects and the at least one action. In one aspect, each re-usable test script may be created to test a specific use-case pertaining to the IT enabled application. In one implementation, the database schema may be defined by the re-usable test script creation module 214.

At block 406, a unique keyword may be assigned to each re-usable test scripts. In one implementation, the unique keyword may be assigned by the keyword assignment module 216.

At block 408, a mapping table comprising mapping of the unique keyword and each of the plurality of re-usable test scripts may be stored. In one implementation, the mapping table may be stored by the mapping module 218.

At block 410, the unique keyword, corresponds to a re-usable test script of the plurality of re-usable test scripts, may be selected from the mapping table. In one aspect, the selection of the unique keyword indicates testing of the specific use-case. In one implementation, the unique keyword may be selected by the keyword selection module 220.

At block 412, the re-usable test script may be executed thereby facilitating automatic testing of the specific use-case pertaining to the IT enabled application. In one implementation, the re-usable test script may be executed by the test script execution module 222.

Exemplary embodiments discussed above may provide certain advantages. Though not required to practice aspects of the disclosure, these advantages may include those provided by the following features.

Some embodiments enable a system and a method to create and execute test suites through intuitive, user friendly interface.

Some embodiments enable a system and a method to achieve complete flexibility with script free testing for non-programmers.

Some embodiments enable a system and a method to speed up the delivery time without sacrificing quality through continuous delivery.

Some embodiments enable a system and a method to leverage integration with release management to define and align.

Some embodiments enable a system and a method to organize and manage all phases of the application lifecycle management process.

Although implementations for methods and systems for automation testing platform for facilitating automatic testing of an Information technology (IT) enabled application have been described in language specific to structural features and/or methods, it is to be understood that the appended claims are not necessarily limited to the specific features or methods described. Rather, the specific features and methods are disclosed as examples of implementations for the automation testing platform facilitating the automatic testing of the IT enabled application.

We claim:

1. A method for facilitating automatic testing of an Information technology (IT) enabled application, the method comprising:
capturing, by a processor (202), one or more objects and at least one action performed on the one or more objects, wherein the one or more objects are present on at least one page of the IT enabled;
creating, by the processor (202), a plurality of re-usable test scripts and a plurality of keywords, wherein the plurality of re-usable test scripts and the plurality of keywords are created based on the one or more objects and the at least one action, wherein each re-usable test script is created to test a specific use-case pertaining to the IT enabled application;
assigning, by the processor (202), a unique keyword, of the plurality of keywords, to each re-usable test scripts;
storing, by the processor (202), a mapping table comprising mapping of the unique keyword and each of the plurality of re-usable test scripts;
selecting, by the processor (202), the unique keyword, corresponds to a re-usable test script of the plurality of re-usable test scripts, from the mapping table, wherein the selection of the unique keyword indicates testing of the specific use-case; and
executing, by the processor (202), the re-usable test script thereby facilitating automatic testing of the specific use-case pertaining to the IT enabled application.

2. The method of claim 1, wherein the plurality of re-usable test scripts is created by monitoring the at least one action performed on the one or more objects and thereby recording the at least one action performed on the one or more objects.

3. The method of claim 1, wherein the mapping table is stored in a system database.

4. The method of claim 1, wherein the IT-enabled application is one of Desktop application, a web-based application, and a mobile application.

5. The method of claim 1 further comprising generating a report comprising test results and a screen-shot indicating at least one bug identified upon execution of the re-usable test script.

6. An automation testing platform (102) for facilitating automatic testing of an Information technology (IT) enabled application, the automation testing platform comprising:
a processor (202); and
a memory (206) coupled to the processor (204), wherein the processor (204) is capable of executing a plurality of modules stored in the memory (204), and wherein the plurality of modules comprising:
a data capturing module 212 for capturing one or more objects and at least one action performed on the one or more objects, wherein the one or more objects are present on at least one page of the IT enabled;
a re-usable test script creation module (214) for creating a plurality of re-usable test scripts and a plurality of keywords, wherein the plurality of re-usable test scripts and the plurality of keywords are created based on the one or more objects and the at least one action, wherein each re-usable test script is created to test a specific use-case pertaining to the IT enabled application;
a keyword assignment module (216) for assigning a unique keyword to each re-usable test scripts;
a mapping module (218) for storing a mapping table comprising mapping of the unique keyword and each of the plurality of re-usable test scripts;
a keyword selection module (220) for selecting the unique keyword, corresponds to a re-usable test script of the plurality of re-usable test scripts, from the mapping table, wherein the selection of the unique keyword indicates testing of the specific use-case; and
a test script execution module (222) for executing the re-usable test script thereby facilitating automatic testing of the specific use-case pertaining to the IT enabled application.

7. The automation testing platform (102) of claim 6, wherein the plurality of re-usable test scripts is created by monitoring the at least one action performed on the one or more objects and thereby recording the at least one action performed on the one or more objects.

8. The automation testing platform (102) of claim 6, wherein the mapping table is stored in a system database.

9. The automation testing platform (102) of claim 6, wherein the IT-enabled application is one of Desktop application, a web-based application, and a mobile application.

10. The automation testing platform (102) of claim 6 further comprising a report generation module (224) for generating a report comprising test results and a screen-shot indicating at least one bug identified upon execution of the re-usable test script.

11. A non-transitory computer readable medium embodying a program executable in a computing device for facilitating automatic testing of an Information technology (IT) enabled application, the program comprising a program code:
a program code for capturing one or more objects and at least one action performed on the one or more objects, wherein the one or more objects are present on at least one page of the IT enabled;
a program code for creating a plurality of re-usable test scripts and a plurality of keywords, wherein the plurality of re-usable test scripts and the plurality of keywords are created based on the one or more objects and the at least one action, wherein each re-usable test script is created to test a specific use-case pertaining to the IT enabled application;
a program code for assigning a unique keyword to each re-usable test scripts;
a program code for storing a mapping table comprising mapping of the unique keyword and each of the plurality of re-usable test scripts;
a program code for selecting the unique keyword, corresponds to a re-usable test script of the plurality of re-usable test scripts, from the mapping table, wherein the selection of the unique keyword indicates testing of the specific use-case; and
a program code for executing the re-usable test script thereby facilitating automatic testing of the specific use-case pertaining to the IT enabled application.
